(19) United States
(12) Patent Application Publication
(10) Pub. No.: US 2015/0171721 A1
(43) Pub. Date: Jun. 18, 2015

(54) AIR GAP VARIABLE MOTOR

(71) Applicant: Hyundai Motor Company, Seoul (KR)

(72) Inventors: Young Jin SEO, Yongin-si (KR); Myeong Kyu JUNG, Seoul (KR); Ki Nam KIM, Seongnam-si (KR); Yeonho KIM, Suwon-si (KR); Dongyeon HAN, Seoul (KR)

(21) Appl. No.: 14/313,747

(22) Filed: Jun. 24, 2014

(30) Foreign Application Priority Data
Dec. 18, 2013 (KR) 10-2013-0158573

(51) Int. Cl. H02K 21/02; B60L 11/18

(52) U.S. Cl. CPC H02K 21/026; B60L 11/1803

(57) ABSTRACT

An air gap-variable driving motor includes a motor housing. A stator has a tapered inner side and is disposed in the motor housing. A rotor is fitted on a shaft inside the stator with an air gap therebetween and has a tapered outside corresponding to the inner side of the stator. An actuator is connected to any one of the stator and the motor and changes the air gap between the stator and the rotor by moving the connected one.

### CROSS-REFERENCE TO RELATED APPLICATION

The present application claims the benefit of priority to Korean Patent Application Number 10-2013-0158573 filed on Dec. 18, 2013, the entire contents of which application are incorporated herein for all purposes by this reference.

### TECHNICAL FIELD

An exemplary embodiment relates to a driving motor of an environmentally-friendly vehicle. More particularly, the present disclosure relates to an air gap-variable driving motor that can selectively change the air gap between a stator and a rotor.

### BACKGROUND

In general, hybrid vehicles or electric vehicles, which are usually called environmentally-friendly vehicles, can generate a driving force, using an electric motor (hereafter, referred to as a “driving motor”) acquiring torque from electric energy.

For example, the hybrid vehicles travel in an electric vehicle (EV) mode, which is a pure electric vehicle mode using only the power from a driving motor, or travel in a hybrid electric vehicle (HEV) mode using torque from both of an engine and a driving motor as power. Common electric vehicles use torque from a driving motor as power when traveling.

As the driving motor used for power source of the environmentally-friendly vehicles, for example, there are a permanent magnet synchronous motor (PMSM) and a wound rotor synchronous motor (WRSM).

Those driving motors are composed of a stator fixed in a housing and generating magnetic flux, and a rotor connected to a driving shaft and rotating. There is an air gap, which is a physical distance for rotation, between the stator and the rotor. The air gap consists of air having magnetic transmittance, which is a magnetic property, of a several thousandths, so that it interferes with the flow of magnetic flux.

Therefore, it is necessary to minimize the air gap that acts as a factor for decreasing the loss of magnetic flux in order to improve the performance of the driving motors. That is, since the smaller the gap between the stator and the rotor, the less the loss of magnetic flux in the driving motors, it is possible to increase torque (output) by minimizing the air gap.

However, the driving motors of the environmentally-friendly vehicles are accompanied by a high rotation rate (over 10,000 RPM in the EV mode), such that there is a limit in reducing the air gap due to an allowable eccentricity limit (rotor balancing grade) in high-speed rotation for the characteristics of the driving motors.

When the rotor balancing grade increases due to the allowable eccentricity limit, convenience of manufacturing a motor is deteriorated and manufacturing cost increases. That is, the air gap of driving motors is set on the basis of the allowable eccentricity (balancing grade) according to the maximum rotation speed of the rotor. The higher the balancing grade, the higher the required precision in machining, such that the manufacturing is difficult, and the price increases.

Further, when the air gap is set on the basis of the maximum rotation speed, it is difficult for the motors to improve their performance in a low speed range. Accordingly, for permanent magnet synchronous motors, the use amount of a magnet by the rotor is increased or the amount of current flowing through the coil of the stator is increased in order to compensate for the increase in magnetic flux in a low speed range. However, there are side effects in this case, such as an increase in manufacturing cost or reduction of efficiency.

Further, it is impossible to directly control field flux in the permanent magnet synchronous motors, such that the induced voltage of the motors changes in accordance with the rotation speed.

Since the induced voltage increases in proportion to the rotation speed, particularly, a voltage higher than the voltage at the inverter, driving the motors is induced in high-speed rotation, such that not driving, but power generation is made.

Accordingly, in order to prevent the high-voltage power generation, a current (reactive current) that generates magnetic flux in the opposite direction to prevent an increase of the magnetic flux associated with the power generation is artificially supplied. However, the increase of the reactive current becomes a loss and reduces the efficiency of the motors. That is, in the high-speed range of the permanent magnet synchronous motors, the smaller the air gap between the stator and the rotor, the more the reactive current increases and the motor efficiency decreases.

Accordingly, there is an effect of directly reducing a non-load flux linkage without increasing the current that generates magnetic flux, if it is possible to increase the air gap between the stator and the rotor in the high-speed range of the permanent magnet synchronous motors. Therefore, it is possible to minimize the motor efficiency and keep the output constant in the high-speed range.

The above information disclosed in this Background section is only for enhancement of understanding of the background of the disclosure, and therefore, it may contain information that does not form the prior art that is already known in this country to a person of ordinary skill in the art.

### SUMMARY

The present disclosure provides an air gap-variable driving motor having advantages of being able to selectively change an air gap between a stator and a rotor in accordance with an operation range of the motor by changing an axial position of the rotor or the stator.

An exemplary embodiment of the present invention provides an air gap-variable driving motor including a motor housing and a stator having a tapered inner side and disposed in the motor housing. A rotor is fitted on a shaft inside the stator with an air gap therebetween and has a tapered outer side corresponding to the inner side of the stator. An actuator is connected to any one of the stator and the rotor and changes the air gap between the stator and the rotor by moving the connected one.

In the air gap-variable driving motor according to an exemplary embodiment of the present invention, the shaft may be axially and movably disposed in the motor housing. The actuator may be connected with the shaft.

In the air gap-variable driving motor according to an exemplary embodiment of the present invention, the shaft may be rotatably supported with both ends on both sides of the motor housing by a bearing.

In the air gap-variable driving motor according to an exemplary embodiment of the present invention, the shaft may be axially and movably supported on both sides of the motor housing by the bearing.

In the air gap-variable driving motor according to an exemplary embodiment of the present invention, the bearing may be slidably fitted on guide rails on both sides of the motor housing.

In the air gap-variable driving motor according to an exemplary embodiment of the present invention, the stator may be disposed movably in an axial direction of the shaft in the motor housing. The actuator may be connected with the stator.

In the air gap-variable driving motor according to an exemplary embodiment of the present invention, the stator may be slidably fitted on guide rails on the inner side of the motor housing.

In the air gap-variable driving motor according to an exemplary embodiment of the present invention, the inner side of the stator may form a tapered surface such that an inner diameter gradually decreases toward one end from another end of the shaft.

In the air gap-variable driving motor according to an exemplary embodiment of the present invention, the outer side of the rotor may form a tapered surface such that an outer diameter gradually decreases toward one end from another end of the shaft.

In the air gap-variable driving motor according to an exemplary embodiment of the present invention, the actuator may be connected to the shaft and may axially reciprocate the shaft, using electromagnetic force.

In the air gap-variable driving motor according to an exemplary embodiment of the present invention, the actuator may be connected to the shaft and may axially reciprocate the shaft, using hydraulic pressure or air pressure.

In the air gap-variable driving motor according to an exemplary embodiment of the present invention, the actuator may be connected to the stator and may reciprocate the stator in the axial direction of the shaft, using electromagnetic force.

In the air gap-variable driving motor according to an exemplary embodiment of the present invention, the actuator may be connected to the stator and may reciprocate the stator in the axial direction of the shaft, using hydraulic pressure or air pressure.

Another embodiment of the present invention provides an air gap-variable driving motor comprising a motor housing, a stator disposed in the motor housing, and a rotor connected to a shaft and disposed inside the stator with an air gap therebetween. The air gap between the stator and the rotor may vary by moving any one of the stator and the rotor in an axial direction of the shaft with an actuator.

In the air gap-variable driving motor according to another exemplary embodiment of the present invention, the stator may form a tapered inner side such that an inner diameter gradually decreases toward one end from another end of the shaft. The rotor may form a tapered outer side such that an outer diameter gradually decreases toward one end from the other end of the shaft.

Another embodiment of the present invention provides an air gap-variable driving motor that includes a stator and a rotor disposed with an air gap from the stator and rotating about a driving shaft. The air gap between the stator and the rotor may be changed by axially reciprocating any one of the stator and the rotor with an actuator.

In the air gap-variable driving motor according to another exemplary embodiment of the present invention, the stator may form a tapered inner side such that an inner diameter gradually decreases toward one end from another end of the driving shaft. The rotor may be disposed inside the stator with an air gap therebetween and may make a tapered outer side such that an outer diameter gradually decreases toward one end from the other end of the driving shaft.

According to the exemplary embodiments of the present invention, it is possible to selectively vary the air gap between the stator and the rotor by changing an axial position of the rotor or the stator with the actuator, depending on an operation range of the motor (low-speed range or high-speed range). Since it is possible to reduce the air gap between the stator and the rotor, using the actuator in the exemplary embodiments of the present invention, it is possible to increase the maximum torque (output) of the motor.

In addition, since it is possible to increase the air gap between the stator and the rotor in a high-speed range, using the actuator in exemplary embodiments of the present invention, it is possible to increase the efficiency of the motor by reducing a reactive current according to small field control.

Further, since an increase in a balancing grade of the rotor due to the air gap in the high-speed range is not generated in exemplary embodiments of the present invention, it is possible to improve the convenience of manufacturing the motor and reduce the manufacturing cost.

### BRIEF DESCRIPTION OF THE DRAWINGS

The drawings are provided for reference in describing exemplary embodiments of the present invention, and the spirit of the present disclosure should not be construed only by the accompanying drawings.

FIG. 1 is a diagram schematically showing an air gap-variable driving motor according to an exemplary embodiment of the present invention.

FIG. 2 is a diagram schematically showing a movement structure of a rotor used for an air gap-variable driving motor according to an exemplary embodiment of the present invention.

FIG. 3 is a diagram illustrating an operation of an air gap-variable driving motor according to an exemplary embodiment of the present invention.

FIG. 4 is a diagram schematically showing an air gap-variable driving motor according to another exemplary embodiment of the present invention.

FIG. 5 is a diagram schematically showing a movement structure of a stator used for an air gap-variable driving motor according to another exemplary embodiment of the present invention.

FIG. 6 is a diagram illustrating an operation of an air gap-variable driving motor according to another exemplary embodiment of the present invention.

### DETAILED DESCRIPTIONS

The present disclosure will be described more fully hereinafter with reference to the accompanying drawings, in which exemplary embodiments of the invention are shown. As those skilled in the art would realize, the described embodiments may be modified in various different ways, all without departing from the spirit or scope of the present disclosure.

The unrelated parts to the description of the exemplary embodiments are not shown to make the description clear, and like reference numerals designate like element throughout the specification.

Further, the sizes and thicknesses of the configurations shown in the drawings are provided selectively for the convenience of description, so that the present disclosure is not limited to those shown in the drawings, and the thicknesses are exaggerated to make some parts and regions clear.

Discriminating the names of components with the first, and the second, etc. in the following description is for discriminating them for the same relationship of the components and the components are not limited to the order in the following description.

Throughout the specification, unless explicitly described to the contrary, the word “comprise” and variations such as “comprises” or “comprising”, will be understood to imply the inclusion of stated elements but not the exclusion of any other elements. Further, the terms, “ . . . unit”, “ . . . mechanism”, “ . . . portion”, “ . . . member” etc. used herein mean the units of inclusive components performing at least one or more functions or operations.

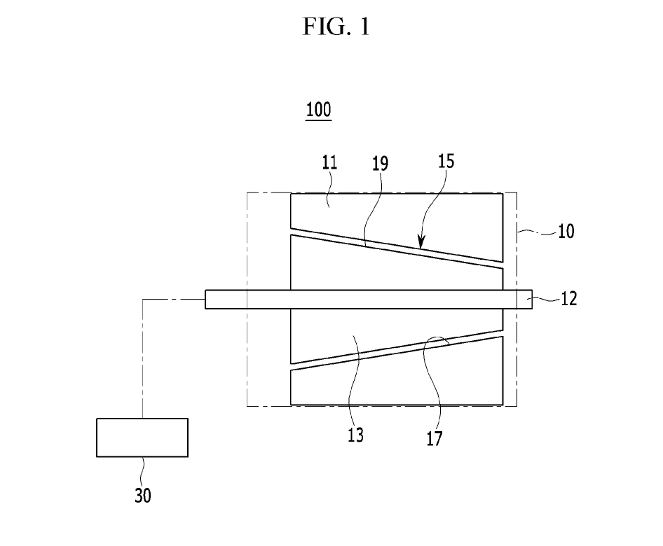

FIG. 1 is a diagram schematically showing an air gap-variable driving motor according to an exemplary embodiment of the present invention. Referring to FIG. 1, an air gap-variable driving motor 100 according to an exemplary embodiment of the present invention may be used for a driving motor acquiring a driving force from electrical energy in environmentally-friendly vehicles.

For example, the air gap-variable driving motor 100 according to an exemplary embodiment of the present invention may be used for a permanent magnet synchronous motor (PMSM) or a wound rotor synchronous motor (WRSM).

The driving motor 100 includes a stator 11 disposed in a housing 10 and generating magnetic flux. A rotor 13 is disposed with an air gap from the stator 11 and rotating about a driving shaft 12.

Based on this structure, the air gap-variable driving motor 100 according to an exemplary embodiment of the present invention may be used for an inner rotor type synchronous motor with the rotor 13 inside the stator 11. The air gap-variable driving motor 100 according to an exemplary embodiment of the present invention may be used for an outer rotor type synchronous motor with the rotor 13 outside the stator 11.

Here, the structure of the inner rotor type synchronous motor with the stator 11 being outside and the rotor 13 rotating inside the stator 11 is exemplified in an exemplary embodiment of the present invention.

The air gap-variable driving motor 100 according to an exemplary embodiment of the present invention has a structure that can selectively change the air gap 15 between the stator 11 and the rotor 13 in accordance with an operation range (low-speed range or high-speed range) of the motor by changing an axial position of the rotor 13 or the stator 11.

For example, an exemplary embodiment of the present invention provides the air gap-variable driving motor 100 that can change the air gap 15 between the stator 11 and the rotor 13 by changing the axial position of the rotor 13.

To this end, in the air gap-variable driving motor 100 according to an exemplary embodiment of the present invention, the stator 11 forms a tapered inner side and fixed to the motor housing 10. In other words, the inner side of the stator 11 forms a tapered surface 17 with an inner diameter gradually decreasing toward one end from the other end of the shaft 12 described above.

Further, in an exemplary embodiment of the present invention, the rotor 13 has an outer side tapered to fit the inner side of the stator 11 and is fitted in the shaft 12 inside the stator 11 with the air gap 15 therebetween. The outer side of the rotor 13 forms a tapered surface 19 with an outer diameter gradually decreasing toward one end from the other end of the shaft 12.

The stator 11 and the rotor 13 are formed by stacking a plurality of insulation-coated electric steel plates to make a core and the tapered inner side, and outer sides can be formed by gradually changing the size of the electric steel plates to be stacked.

When the core of the stator 11 and the rotor 13 (also referred usually as to a soft magnetic powder core (SMC)) is formed by sintering iron powder coated with resin, the tapered inner side and outer sides may be formed by sintering or molding.

The air gap-variable driving motor 100 according to an exemplary embodiment of the present invention includes an actuator 30 that changes the axial position of the rotor 13 and reciprocates the rotor 13 axially on the shaft 12 to change the air gap between the stator 11 and the rotor 13.

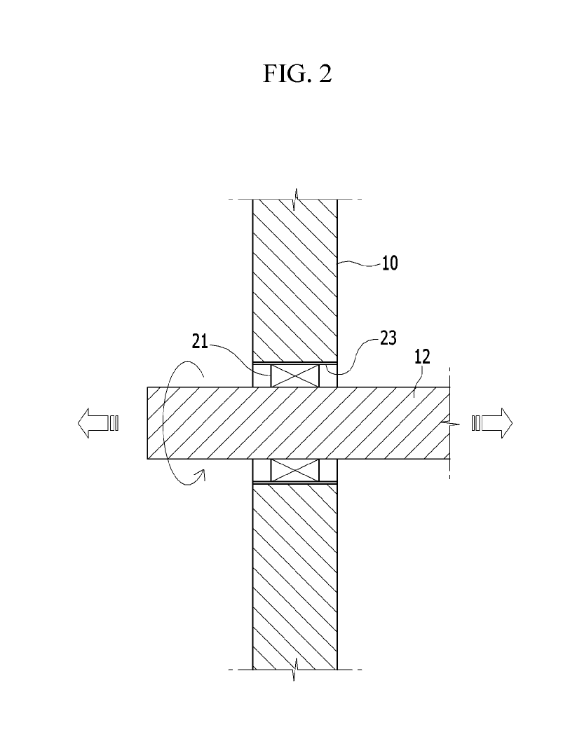

Before describing the actuator 30, in order to reciprocate the rotor 13 on the shaft 12, as shown in FIG. 2, the shaft 12 can be disposed to be axially movable in the motor housing 10, with both ends rotatably supported by a bearing 21 on both sides of the motor housing 10. That is, the shaft 12 is supported to be axially movable on both sides of the motor housing 10 by the bearing 21, and to this end, the bearing 21 is slidably fitted on guide rails 23 on both sides of the motor housing 10. Sliding protrusions fitted in the guide rails 23 are formed on the outer race of the bearing 21 so that the bearing 21 can be slidably fitted on the guide rails 23 of the motor housing 10.

The actuator 30 provides a force to move the rotor 13 axially forward/backward on the shaft 12 and is connected to the shaft 12 of the rotor 13. The actuator 30 may have a structure that axially reciprocates the shaft 12 of the rotor 13, using electromagnetic force.

For example, the actuator 30 may include a core with coil wound on the outer side, a shaft made of steel as an armature and moving when a current is supplied to the coil, and a return spring returning the steel shaft when the current supplied to the coil is removed. The actuator 30 that is operated by the electromagnetic force may include the core with the coil wound on the outer side and a permanent magnet moving in opposite directions in accordance with the direction of the current supplied to the coil. The steel shaft and the permanent magnet may be connected to the shaft 12 of the rotor 13, through a connector such as a bearing in order not to interfere with rotation of the shaft 12.

The actuator 30 generating an operation force, using electromagnetic force, is an electromagnet actuator well known in the art, and thus, the detailed description for the configuration is not provided herein.

The actuator 30 may have a structure that axially reciprocates the shaft 12 of the rotor 13, using hydraulic pressure or air pressure. For example, the actuator 30 may include an actuating cylinder that has ports for input and output of hydraulic pressure or air pressure with a reciprocating piston moved by hydraulic pressure or air pressure therein.

The piston of the actuating cylinder may be connected to the shaft 12 of the rotor 13, through a connector such as a bearing in order not to interfere with rotation of the shaft 12. The actuating cylinder may be a hydraulic or pneumatic actuating cylinder known in the art, and thus, the configuration is not described in detail herein.

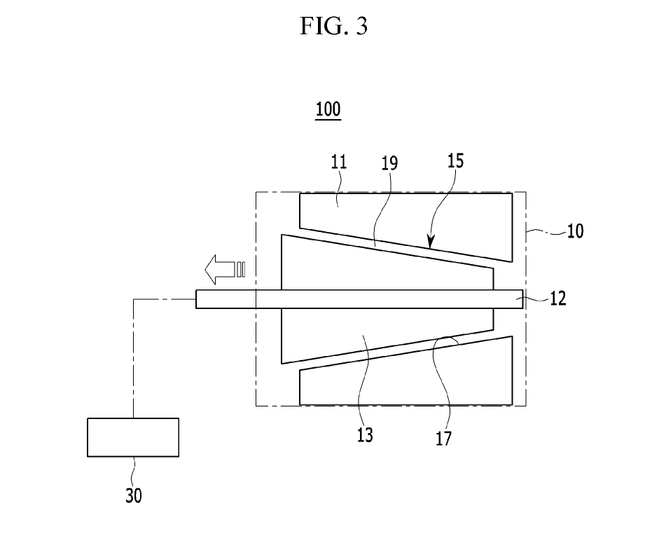

According to the air gap-variable driving motor 100 according to an exemplary embodiment of the present invention having the configuration described above, the actuator 30 applies a backward operation force to the shaft 12 of the rotor 13 in a high-speed range that needs a high rotation speed, as shown in FIG. 3. Accordingly, the rotor 13 moves to the inner side with a larger diameter of the stator 11 by the actuator 30. Therefore, in an exemplary embodiment of the present invention, the air gap 15 between the stator 11 and the rotor 13 can be increased.

When the backward operation force is applied to the shaft 12 by the actuator 30, the bearing 21 supporting the shaft 12 for the rotation can move to the inner side with the larger diameter of the stator 11 while moving in a direction along the guide rails 23 of the motor housing 10.

In contrast, a forward operation force is applied to the shaft 12 of the rotor 13 by the actuator 30 in a low-speed range that needs a low rotation speed. Then, the rotor 13 moves to the inner side with a smaller diameter of the stator 11 by the actuator 30. Therefore, in an exemplary embodiment of the present invention, as shown in FIG. 1, the air gap 15 between the stator 11 and the rotor 13 can be decreased.

In this case, when the forward operation force is applied to the shaft 12 by the actuator 30, the bearing 21 supporting the shaft 12 for the rotation can move to the inner side with the smaller diameter of the stator 11 while moving in an opposite direction along the guide rails 23 of the motor housing 10.

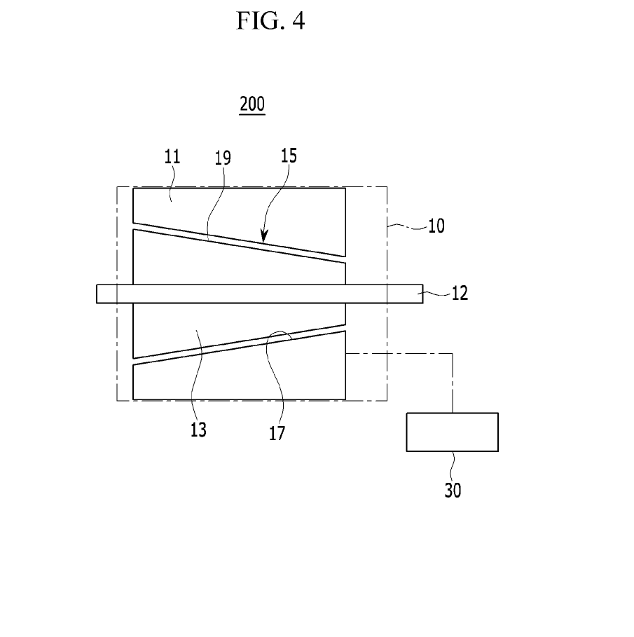

FIG. 4 is a diagram schematically showing an air gap-variable driving motor according to another exemplary embodiment of the present invention. The same components as those of the exemplary embodiment described above are given the same reference numerals. Referring to FIG. 4, the air gap-variable driving motor 200 according to another exemplary embodiment of the present invention can change the air gap 15 between the stator 11 and the rotor 13 by changing the axial position of the stator 11 with the actuator 30.

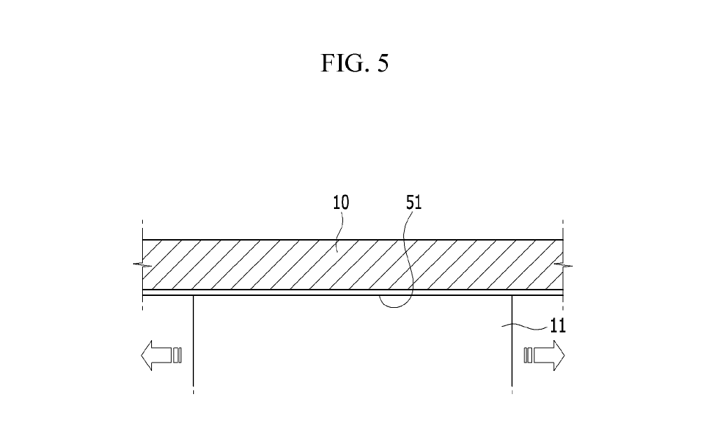

In order to reciprocate the shaft 11 in the axial direction of the shaft 12, as shown in FIG. 5, the stator 11 may be supported on the inner side of the motor housing 10, to be reciprocated in the axial direction of the shaft 12. To this end, the stator 11 may be fitted on guide rails 51 formed on the inner side of the motor housing 10 to slide in the axial direction of the shaft 12. It is apparent that sliding protrusions fitted in the guide rails 51 are formed on the outer side of the stator 11 so that the stator 11 can be slidably fitted on the guide rails 51 in the motor housing 10.

The actuator 30 provides a force for moving the stator 11 forward/backward in the axial direction of the shaft 12 and is connected with the stator 11. The actuator 30 may have a structure that axially reciprocates the stator 11, using electromagnetic force.

For example, the actuator 30 may include a core with a coil wound on the outer side, a shaft made of steel as an armature and moving when a current is supplied to the coil, and a return spring returning the steel shaft when the current supplied to the coil is removed. Further, the actuator 30 that is operated by the electromagnetic force may include the core with the coil wound on the outer side and a permanent magnet moving in the opposite directions in accordance with the direction of the current supplied to the coil. The steel shaft and the permanent magnet may be connected to the stator 11.

The actuator 30 generating an operation force, using electromagnetic force, is an electromagnet actuator well known in the art, and thus, the detailed description for the configuration is not provided herein.

The actuator 30 may have a structure that axially reciprocates the stator 11, using hydraulic pressure or air pressure.

For example, the actuator 30 may include an actuating cylinder that has ports for input and output of hydraulic pressure or air pressure with a piston reciprocating in straight line motion by the hydraulic pressure or the air pressure therein. The piston of the actuating cylinder may be connected to the stator 11. The actuating cylinder is a hydraulic or pneumatic actuating cylinder known in the art, so the configuration is not described in detail herein.

Another configuration of the air gap-variable driving motor 100 according to another exemplary embodiment of the present invention is the same as that in the exemplary embodiment described above, so it is not described in detail herein.

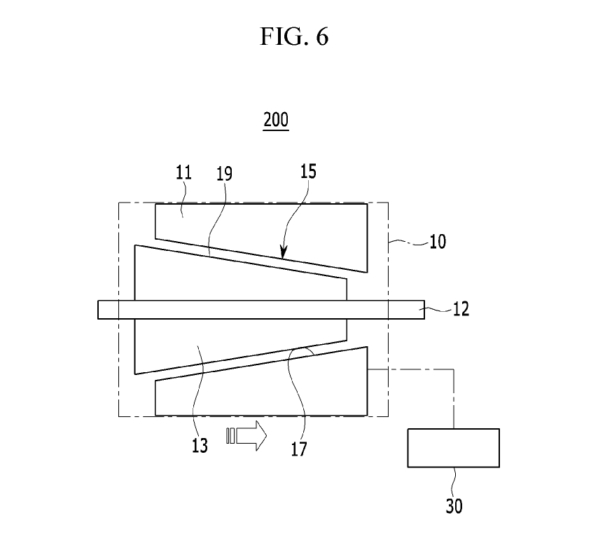

According to the air gap-variable driving motor 200 according to another exemplary embodiment of the present invention having the configuration described above, the actuator 30 applies a backward operation force to the stator 11, as shown in FIG. 6. Then, the stator 11 moves to the inner side with a smaller diameter by the actuator 30. Therefore, in an exemplary embodiment of the present invention, the air gap 15 between the stator 11 and the rotor 13 can be increased.

When the backward operation force is applied by the actuator 30, the stator can move to the inner side with the smaller diameter while moving in one direction along the guide rails 51. In contrast, a forward operation force is applied to the stator 11 by the actuator 30 in a low-speed range that needs a low rotation speed.

Then, the stator 11 moves to the inner side with a larger diameter by the actuator 30. Therefore, in an exemplary embodiment of the present invention, as shown in FIG. 4, the air gap 15 between the stator 11 and the rotor 13 can be decreased. When the forward operation force is applied by the actuator 30, the stator can move to the inner side with the larger diameter while moving in the other direction along the guide rails 51.

According to the air gap-variable driving motors 100 and 200 according to exemplary embodiments of the present invention, it is possible to selectively change the air gap 15 between the stator 11 and the rotor 13 by changing the axial position of the rotor 13 or the stator 11, depending on the operation ranges of the motors (low-speed range or high-speed range), with the actuator 30.

Accordingly, since it is possible to reduce the air gap 15 between the stator 11 and the rotor 13, using the actuator 30 in the exemplary embodiments of the present invention, it is possible to increase the maximum torque (output) of the motors.

Further, since it is possible to increase the air gap 15 between the stator 11 and the rotor 13 in the high-speed range, using the actuator 30 in exemplary embodiments of the present invention, it is possible to increase the efficiency of the motors by reducing a reactive current according to small field control.

Further, since an increase in the balancing grade of a rotor as in the related art is not generated in exemplary embodiments of the present invention, it is possible to improve the convenience of manufacturing a motor and reduce the manufacturing cost.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. An air gap variable driving motor comprising:
a motor housing;
a stator having a tapered inner side and disposed in the motor housing;
a rotor fitted on a shaft inside the stator with an air gap therebetween and having a tapered outer side corresponding to the inner side of the stator; and
an actuator connected to any one of the stator and the rotor and changing the air gap between the stator and the rotor by moving the connected one.

2. The air gap variable driving motor of claim 1, wherein:
the shaft is axially movably disposed in the motor housing, and
the actuator is connected with the shaft.

3. The air gap variable driving motor of claim 2, wherein the shaft is rotatably supported with both ends on both sides of the motor housing by a bearing.

4. The air gap variable driving motor of claim 3, wherein the shaft is axially movably supported on both sides of the motor housing by the bearing.

5. The air gap variable driving motor of claim 4, wherein the bearing is slidably fitted on guide rails on both sides of the motor housing.

6. The air gap variable driving motor of claim 1, wherein:
the stator is disposed movably in an axial direction of the shaft in the motor housing, and
the actuator is connected with the stator.

7. The air gap variable driving motor of claim 6, wherein the stator is slidably fitted on guide rails on the inner side of the motor housing.

8. The air gap variable driving motor of claim 1, wherein:
the inner side of the stator forms a tapered surface such that the inner diameter gradually decreases toward one end from another end of the shaft.

9. The air gap variable driving motor of claim 8, wherein:
the outer side of the rotor forms a tapered surface such that the outer diameter gradually decreases toward one end from the other end of the shaft.

10. The air gap variable driving motor of claim 2, wherein:
the actuator is connected to the shaft and axially reciprocates the shaft, using electromagnetic force.

11. The air gap variable driving motor of claim 2, wherein:
the actuator is connected to the shaft and axially reciprocates the shaft, using hydraulic pressure or air pressure.

12. The air gap variable driving motor of claim 6, wherein:
the actuator is connected to the stator and reciprocates the stator in the axial direction of the shaft, using electromagnetic force.

13. The air gap variable driving motor of claim 6, wherein:
the actuator is connected to the stator and reciprocates the stator in the axial direction of the shaft, using hydraulic pressure or air pressure.

14. An air gap variable driving motor comprising a motor housing, a stator disposed in the motor housing, and a rotor connected to a shaft and disposed inside the stator with an air gap therebetween,
wherein the air gap between the stator and the rotor varies by moving any one of the stator and the rotor in an axial direction of the shaft with an actuator.

15. The air gap-variable driving motor of claim 14, wherein:
the stator forms a tapered inner side such that an inner diameter gradually decreases toward one end from another end of the shaft, and
the rotor forms a tapered outer side such that the outer diameter gradually decreases toward one end from the other end of the shaft.

16. An air gap-variable driving motor comprising
a stator and a rotor disposed with an air gap from the stator and rotating about a driving shaft,
wherein the air gap between the stator and the rotor varies by axially reciprocating any one of the stator and the rotor with an actuator.

17. The air gap-variable driving motor of claim 16, wherein:
the stator forms a tapered inner side such that the inner diameter gradually decreases toward one end from another end of the driving shaft, and the rotor is disposed inside the stator with the air gap therebetween and forms a tapered outer side such that the outer diameter gradually decreases toward one
end from the other end of the driving shaft.
